(19) United States
(12) Patent Application Publication
(10) Pub. No.: US 2007/0234510 A1
(43) Pub. Date: Oct. 11, 2007

(54) Hollow spindle door closer

(76) Inventor: George Toledo, Fallbrook, CA (US)

Correspondence Address: GREER, BURNS & CRAIN, 300 S WACKER DR, 25TH FLOOR, CHICAGO, IL, 60606, US

(21) Appl. No.: 11/398,862

(22) Filed: Apr. 5, 2006

(51) Int. Cl. E05F 1/08

(52) U.S. Cl. 16/72

(57) ABSTRACT

A door closer includes a housing, a spindle carried in the housing, being exposed at a top side and a bottom side of the housing and arranged to rotate about an axis relative to the housing, and a passage through the spindle comprising a passage through the housing. The passage provides a means for wires or other conduits to pass from the door frame into the door, without being exposed outside of the door frame and door.

### BACKGROUND OF THE INVENTION

The present invention relates to door closers, and particularly door closers that attach to the door via a rotatable spindle.

Door closers are well known, including door closers wherein the door closer attaches to the door via a rotatable spindle.

In some situations, electrical power, or conduits for other signal transmissions or provision of fluids, such as water, need to be extended from a wall or door frame to the door itself, which requires lines extending outside the door and door frame that may become twisted or overworked as the door pivots repeatedly between an open and closed position. It is known to provide access through a hollow hinge for a conduit or wires, to extend from a cabinet into a door, such as in a refrigerator door, however, even in such a situation, the wires or conduit must exit the cabinet to enter into the hinge, since the hinge pin area is exposed on the exterior of the door and cabinet.

In the situation of a door, such as a door for a house or office, in order to have the conduit or wire extend from the door frame or wall into the hinge, the conduit or wire would be required to exit out of the door frame or hinge, causing an unsightly condition, and subjecting the wire or conduit to twisting or other mechanical wear.

### SUMMARY OF THE INVENTION

The present invention provides a door closer comprising a housing, a spindle carried in the housing, being exposed at a top side and a bottom side of the housing and arranged to rotate about an axis relative to the housing, and a passage through the spindle comprising a passage through the housing.

In an embodiment, the passage is coaxial with the axis.

In an embodiment, the housing is filled with hydraulic fluid.

In an embodiment, a seal member is arranged between the rotatable spindle and the housing adjacent to a point in the housing where the spindle is exposed.

In an embodiment, the spindle protrudes from at least one of the top and bottom sides.

In an embodiment, the spindle is flush with at least one of the top and bottom sides.

In an embodiment, the spindle has a first end and a second end and the housing comprises a cast body and a removable cover plate, with the spindle extending through the casting at one of the ends and through the removable cover plate at the other of the ends.

In an embodiment, the invention provides a door closer comprising a housing having a top face and a bottom face, a spindle rotatably mounted in the housing for connecting the closer to a door, the spindle being exposed at a first end at the top face and at a second end at the bottom face, a cylinder formed interiorly of the housing, a piston operable in the housing,

a cam and cam follower arrangement interconnecting the piston and the spindle for movement of the piston upon rotation of the spindle, and a passage extending through the spindle from the first end to the second end.

In an embodiment, the invention provides a door closer comprising a housing having a top face and a bottom face, a spindle rotatably mounted in the housing for connecting the closer to a door, the spindle being exposed at a first end at the top face and at a second end at the bottom face, a cylinder formed interiorly of the housing, a piston operable in the cylinder, a carrier plate connected to the piston and slidably mounted within the housing about the spindle, a cam follower carried by the plate, a cam carried by the spindle to rotate with the spindle, the cam having a cam surface engageable with the cam follower to cause the plate to slide within the housing upon rotation of the cam, a spring member adapted to be compressed upon rotation of the spindle in a door opening direction and as the plate slides towards the cylinder and to bias the plate in a direction away from the cylinder.

These and other features and advantages of the present invention will become apparent upon a reading of the detailed description and a review of the accompanying drawings. Specific embodiments of the present invention are described herein. The present invention is not intended to be limited to only these embodiments. Changes and modifications can be made to the described embodiments and yet fall within the scope of the present invention.

### BRIEF DESCRIPTION OF THE DRAWING

FIG. 1 is a plan view of a door closer connected to a door and a door frame.

FIG. 2 is a bottom view of the door closer of FIG. 1 with a portion of the housing removed to illustrate the general components of the closer mechanism.

FIG. 3 is a partial side sectional view of the door closer housing, with some components removed for clarity.

### DETAILED DESCRIPTION OF THE PREFERRED EMBODIMENT

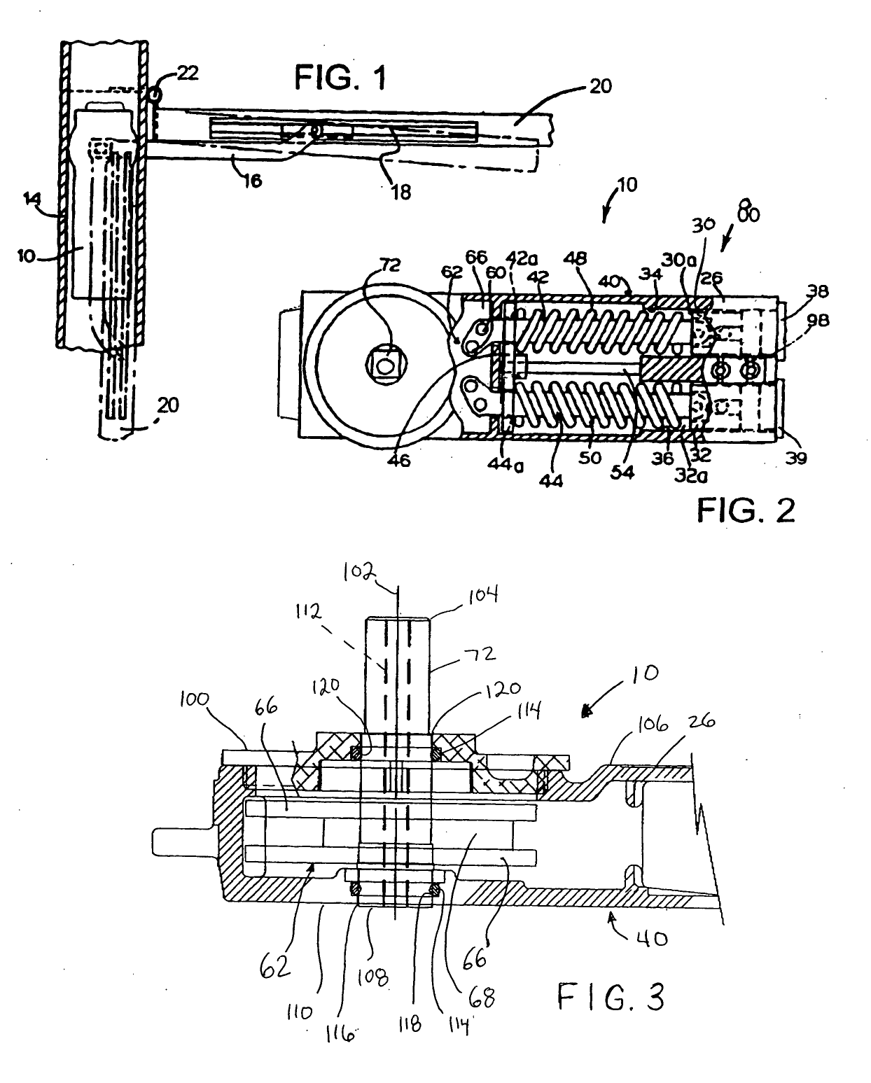

FIGS. 1 and 2 generally illustrate a door closer mechanism for which the present invention is particularly useful. Many different constructions of door closer mechanisms may incorporate the present invention, such as those disclosed in U.S. Pat. Nos. 6,397,430, 6,260,236, 5,829,097, 5,802,670, 5,666,692, 5,050,268, the disclosures of each of which are incorporated herein by reference.

FIG. 1 illustrates a top plan view of a door closer 10 mounted in the transom above the door overhead or lintel 14 and connected by a closing lever 16 to a slide rail 18 that is mounted to a door 20. The door 20 pivots about hinges 22 from an open position as illustrated to a closed position shown in phantom view in FIG. 1. Alternately, the door closer 10 can be mounted to the door 20 and an appropriate lever structure can connect the door closer to a sliding attachment mounted to the door overhead or lintel, although this construction is not shown in the drawings.

FIG. 2 shows the door closer 10 in bottom view. A cover 26 is partially removed to expose the components within the closer. Two pistons 30 and 32 are closely confined within respective cylinders 34 and 36 within a cylinder head portion 80 of a housing 40 of the closer mechanism 10. The cylinders 34 and 36 are closed by caps 38 and 39 respectively. The pistons 30 and 32 are connected to reciprocable rods 42 and 44 respectively. The rods 42 and 44 pass through apertures 42a and 44a through a compression plate 46 which is movable within the housing 40. A first spring 48 and a second spring 50 are located between the compression plate 46 and the pistons 30 and 32, respectively. An adjusting screw 54 is connected to the compression plate 46 and when turned about its axis will move the compression plate longitudinally within the housing 40. By doing so, the spring tension can be altered in order to change the closing force characteristics.

The rods 42 and 44 are connected by screws 60 to a cam chassis 62 including a pair of cam plates 66 that are connected to and sandwich therebetween a cam 68 (FIG. 3) which is further connected to co-rotate with a spindle 72 extending downwardly through the housing 40.

The spindle 72 may be connected to the door 20 either by means of the closing lever 16 or directly, such that the door pivots about a rotational axis of the spindle.

Upon rotation of the spindle 72 by rotation of the door 20, the cam 68 forces the chassis 62 to move or slide longitudinally within the housing 40. The position illustrated in FIG. 2 corresponds to a door closed position. Upon rotation of the spindle 72, the chassis 62 moves in a direction towards the right within the housing 40, as viewed in FIG. 2. This movement drives the pistons 30 and 32 in a door opening stroke within the housing 40 which further compresses the springs 48 and 50 against the compression plate 46.

When the pistons 30 and 32 are forced to the left in FIG. 2, oil, such as hydraulic oil, or another viscous fluid that is held within the housing 40 is compressed by the movement of the pistons. The fluid under pressure is forced from backsides 30a and 32a of the pistons 30 and 32, respectively, through a series of valves and passageways, within the cylinders 34 and 36. Particular design details of the passageways and valves and the adjustment of the screw 54 can significantly alter the characteristics of the door closer 10 in both the opening and closing cycles as is known. The general door closer 10 described and illustrated in FIGS. 1 and 2 is provided herein for illustrating the present invention. The door closer construction can change considerably and yet fall within the scope of the present invention. Additionally, the adjustment screw 54 and compression plate 46 can be eliminated and yet the door closer 10 can fall within the scope of the invention.

FIG. 3 illustrates a partial side sectional view of the door closer 10 showing the exterior housing 40 and a removable cover plate 100. The spindle 72 is rotatably mounted in the housing 40 so as to rotate about an axis 102. The spindle 72 is exposed at a first end 104 at a top side 106 of the housing and is exposed at a second end 108 at a bottom side 110 of the housing. A passage 112 extends through the spindle 72 comprising a passage through the housing 40. In an embodiment of the invention, the passage 112 is coaxial with the axis of rotation 102 of the spindle 72.

In an embodiment, particularly where the housing 40 is filled with a viscous fluid, a seal member 114 is arranged between the rotatable spindle 72 and the housing adjacent to a point in the housing where the spindle is exposed. Specifically, the housing 40 may have a hole 116 in the bottom side 110 with a first seal member 114 positioned on an inside seat 118 surrounding the hole 116. The removable cover plate 100 may have a hole 120 which is at the top side 106 of the housing 40, with a second seal member 114 positioned on an inside seat 120 surrounding the hole 120. The seal members 114 may comprise O-rings.

The spindle 72 may protrude from at least one of the top 106 and bottom 110 sides, here shown protruding at the top side. The spindle 72 may be essentially flush with at least one of the top 106 and bottom 110 sides, here shown being flush with the bottom side.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

I claim:

1. A door closer comprising:
a housing,
a spindle carried in said housing, being exposed at a top side and a bottom side of said housing, and arranged to rotate about an axis relative to said housing,
a passage through said spindle comprising a passage through said housing.

2. A door closer according to claim 1, wherein said passage is coaxial with said axis.

3. A door closer according to claim 1, wherein said housing is filled with hydraulic fluid.

4. A door closer according to claim 3, including a seal member arranged between said rotatable spindle and said housing adjacent to a point in said housing where said spindle is exposed.

5. A door closer according to claim 1, wherein said spindle protrudes from at least one of said top and bottom sides.

6. A door closer according to claim 1, wherein said spindle is flush with at least one of said top and bottom sides.

7. A door closer according to claim 1, wherein said spindle has a first end and a second end and said housing comprises a cast body and a removable cover plate, with said spindle extending through said casting at one of said ends and through said removable cover plate at the other of said ends.

8. A door closer comprising:
a housing having a top face and a bottom face,
a spindle rotatably mounted in said housing for connecting said closer to a door,
said spindle being exposed at a first end at said top face and at a second end at said bottom face,
a cylinder formed interiorly of said housing,
a piston operable in said housing,
a cam and cam follower arrangement interconnecting said piston and said spindle for movement of said piston upon rotation of said spindle, and
a passage extending through said spindle from said first end to said second end.

9. A door closer according to claim 8, wherein said spindle protrudes from at least one of said top and bottom face.

10. A door closer according to claim 8, wherein said spindle is flush with at least one of said top and bottom face.

11. A door closer according to claim 8, wherein said housing is sealed and is filled with hydraulic fluid.

12. A door closer according to claim 11, including a seal member arranged between said rotatable spindle and said housing adjacent to a point in said housing where said first end and said second end are exposed.

13. A door closer according to claim 8, wherein said housing comprises a cast body and a removable cover plate, with said spindle extending through said casting at one of said ends and through said removable cover plate at the other of said ends.

14. A door closer according to claim 8, wherein said spindle is rotatable about an axis and said passage is coaxial with said axis.

15. A door closer comprising:
a housing having a top face and a bottom face,
a spindle rotatably mounted in said housing for connecting said closer to a door,
said spindle being exposed at a first end at said top face and at a second end at said bottom face,
a cylinder formed interiorly of said housing,
a piston operable in said cylinder,
a carrier plate connected to said piston and slidably mounted within said housing about said spindle,
a cam follower carried by said plate,
a cam carried by said spindle to rotate with said spindle,
said cam having a cam surface engageable with said cam follower to cause said plate to slide within said housing upon rotation of said cam,
a spring member adapted to be compressed upon rotation of said spindle in a door opening direction and as said plate slides towards said cylinder and to bias said plate in a direction away from said cylinder.

16. A door closer according to claim 15, wherein said spindle protrudes from at least one of said top and bottom face.

17. A door closer according to claim 15, wherein said spindle is flush with at least one of said top and bottom face.

18. A door closer according to claim 15, wherein said housing is sealed and is filled with hydraulic fluid.

19. A door closer according to claim 18, including a seal member arranged between said rotatable spindle and said housing adjacent to a point in said housing where said first end and said second end are exposed.

20. A door closer according to claim 15, wherein said housing comprises a cast body and a removable cover plate, with said spindle extending through said casting at one of said ends and through said removable cover plate at the other of said ends.
